(19) United States
(12) Patent Application Publication
(10) Pub. No.: US 2015/0254739 A1
(43) Pub. Date: Sep. 10, 2015

(54) System and Method for Making Gym Equipment Available for Easy Fitness

(71) Applicant: Mary Ellen Hoye, Homer Glen, IL (US)

(72) Inventor: Mary Ellen Hoye, Homer Glen, IL (US)

(21) Appl. No.: 14/196,040

(22) Filed: Mar. 4, 2014

(51) Int. Cl. G06Q 30/04; G06Q 30/02

(52) U.S. Cl. CPC G06Q 30/04; G06Q 30/0241

(57) ABSTRACT

A system and method where fitness equipment that can be located at stores, coffee shops, airports and any other place where people gather and can easily access when they have a few extra minutes, or they must wait for a known amount of time. The fitness equipment can be accessed by membership or by credit card. An optional television monitor can display advertisements and/or fitness information or general news, weather or the like. The fitness equipment can optionally track usage by a member as part of a fitness or insurance program.

### BACKGROUND

1. Field of the Invention

The present invention relates to fitness and gym or exercise equipment, and more particularly to a system and method for making gym equipment available in convenient places for easy fitness.

2. Description of the Prior Art

Many people lead lives that are so busy and scheduled such that the very need to drive to a particular gym or exercise facility steals from the thirty minutes to one hour or free time they may have for the day. It is recommended to exercise for a minimum of 20 to 30 minutes per day to keep in shape at the very least, and possibly for the purpose of keeping insurance rates lower.

It is well known that there are various stores, coffee shops and other locations located virtually everywhere, where people gather, that are easy to access and very convenient.

It would be advantageous to have a system and method for locating gym or other exercise equipment in these stores and locations so that visitors could have the convenience of what might be called a “gym on the go” designed to accommodate people's very busy schedules and yet provide an adequate fitness opportunity.

### SUMMARY OF THE INVENTION

Fitness equipment that can be located at stores, coffee shops, airports and any other place where people gather and can easily access when they have a few extra minutes, or they must wait for a known amount of time. The fitness equipment can be accessed by membership or by credit card. An optional television monitor can display advertisements and/or fitness information or general news, weather or the like. The fitness equipment can optionally track usage by a member as part of a fitness or insurance program.

### DESCRIPTION OF THE DRAWINGS

Drawings are now presented to illustrate features of the present invention.

FIG. 1 shows a floor layout of a coffee shop with an embodiment of the present invention installed.

FIG. 2 shows a diagram with embodiments of the present invention

connected by a network that is tied to a billing service and to insurance. Several illustrations have been presented to aid in understanding the present invention. The scope of the present invention is not limited to what is shown in the figures.

### DESCRIPTION OF THE INVENTION

The present invention relates to placing several pieces of fitness equipment in stores, coffee shops or other convenient locations throughout a neighborhood for people to use when they have ten minutes or more to wait, but nothing else to do. This equipment can be located in a separate room or cubicle or simply be off to the side. For example, a parent waiting for a child to finish a music lesson, or someone waiting for a relative dropped off at the doctor, could exercise during the wait by simply dropping into a next-door coffee shop.

The cubical or location could be equipped with a coat hanger for coats and have a friendly ambience. The invention can include an optional television that could pay fitness videos, run advertisements, show weather or news or show any other programming. The store hosting the fitness equipment could charge for it by accepting a credit card, or by maintaining accounts for frequent users. Regular members could carry an access card. Different groups of participating stores can honor the same access or membership card. The store could also be paid to run particular advertisements on the television or monitor. In particular local or national advertisers can pay most of the cost of the equipment just to get healthy busy people to watch their ads. The small amount of space taken up by the equipment may also pay for itself by attracting more people into the business. Customers may arrange their schedules that they know will include waits or free periods so that they can use the equipment.

The present invention also works well in airports where people spend large amounts of time simply waiting for planes to arrive or board. A small room near the gates could attract numerous people who know they must wait another half hour to board.

The present invention is not limited just to local groups of businesses, but could be nationwide or even world-wide. The same access or membership card could, for example, be recognized at every airport, or at every coffee shop of a certain brand, or even more generally, be universally recognized. Billing and reimbursement to the store could be handled online by one of several universal billing services known in the art. Any payment system, and in particular, any online payment system is within the scope of the present invention.

Typical fitness equipment can include a stepper, a treadmill, possibly weights and any other type of fitness or exercise equipment. Any type of fitness equipment is within the scope of the present invention. For regular members, the equipment in a group of stores could maintain a fitness record or even tracking for insurance credit. The system can even be part of a health care insurance program.

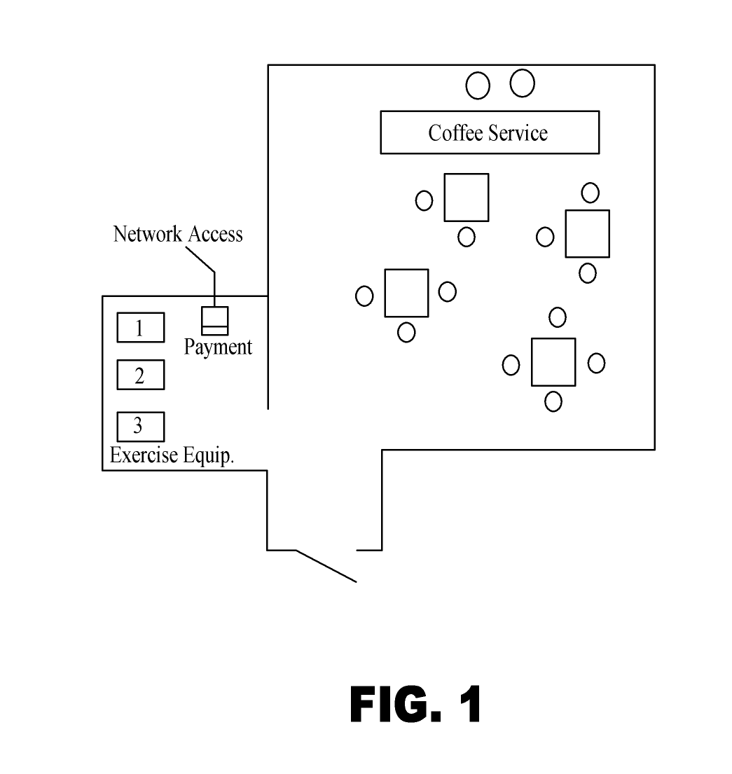

FIG. 1 shows a coffee shop with fitness equipment located in a room adjacent the entrance. Several pieces of equipment can be seen, along with a payment station that can accept either a credit card or a membership card, and which has network access.

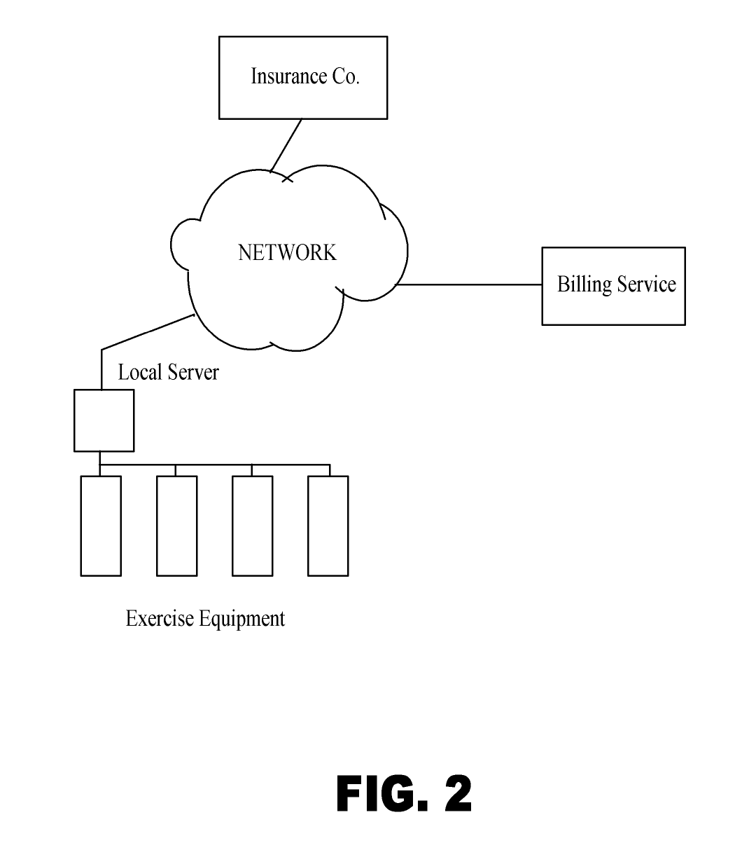

FIG. 2 shows a server managing several pieces of exercise equipment in a retail establishment coupled to a network that ultimately connects to a billing service and an optional insurance company.

Several descriptions and illustrations have been presented to aid in understanding the present invention. One with skill in the art will realize that numerous changes and variations may be made without departing from the spirit of the invention. Each of these changes and variations is within the scope of the present invention.

I claim:

1. A method for promoting health and fitness comprising:
placing a plurality of fitness or exercise equipment in a non-gym retail business establishment adapted to be easily accessible to users having to wait for predetermined times;
coupling said fitness or exercise equipment to a billing service over a network adapted to charge said users for using said fitness or exercise equipment;
placing a monitor near said fitness equipment adapted to display advertisements.

2. The method of claim 1 further comprising issuing membership cards to users allowing access to said fitness or exercise equipment.

3. The method of claim 1 wherein said users are billed on their credit cards.

4. The method of claim 1 further comprising coupling said fitness or exercise equipment to an insurance company over said network, wherein the insurance company receives reports when members use said exercise equipment.

5. A system for promoting fitness comprising:
a plurality of exercise equipment located in a non-gym retail business establishment;
a network interface located in said business establishment;
a pay station also located in said business establishment;
wherein, each of said plurality of exercise equipment is data connected to said network interface and said pay station;
an insurance company located remote to said business establishment in communication over the network with said exercise equipment;
a billing service located remote to said business establishment in communication over the network with said pay station;
whereby, a user can pay at said pay station to use one or more of said plurality of exercise equipment for a particular interval, and a message is sent to the insurance company over the network recording usage of said exercise equipment by that particular user for insurance credit.

6. The system of claim 5 wherein said pay station is configured to bill user's credit cards.

7. The system of claim 5 wherein said pay station is configured to accept user membership cards.
